(19) United States
(12) Patent Application Publication
(10) Pub. No.: US 2018/0162887 A1
(43) Pub. Date: Jun. 14, 2018

(54) METATITANIC ACID PARTICLE, COMPOSITION FOR FORMING PHOTOCATALYST, AND PHOTOCATALYST

(71) Applicant: FUJI XEROX CO., LTD., Tokyo (JP)

(72) Inventors: Hiroyoshi OKUNO, Kanagawa (JP); Hideaki YOSHIKAWA, Kanagawa (JP); Yasunobu KASHIMA, Kanagawa (JP); Takeshi IWANAGA, Kanagawa (JP); Sakae TAKEUCHI, Kanagawa (JP)

(73) Assignee: FUJI XEROX CO., LTD., Tokyo (JP)

(21) Appl. No.: 15/484,407

(22) Filed: Apr. 11, 2017

(30) Foreign Application Priority Data
Dec. 12, 2016 (JP) 2016-240464

(51) Int. Cl. C07F 7/28; B01J 31/02; B01J 31/14; B01J 31/06; B01J 31/12; B01J 35/00; B01J 37/04; B01J 37/03; B01J 37/00; B01J 37/06

(52) U.S. Cl. CPC C07F 7/28; B01J 31/0274; B01J 31/143; B01J 31/06; B01J 31/127; B01J 37/06; B01J 35/0006; B01J 37/04; B01J 37/033; B01J 37/009; B01J 35/004

(57) ABSTRACT

A metatitanic acid particle including bonded thereon a metal-containing compound which has a hydrocarbon group, wherein the metatitanic acid particle has an absorption at 450 nm and 750 nm in a visible absorption spectrum, and with respect to a surface of the particle, an element ratio M/Ti between metal M of the metal-containing compound and titanium is from 0.1 to 0.4 and an element ratio C/Ti between carbon C and titanium is from 0.3 to 1.2.

### CROSS-REFERENCE TO RELATED APPLICATIONS

This application is based on and claims priority under 35 USC 119 from Japanese Patent Application No. 2016-240464 filed Dec. 12, 2016.

### BACKGROUND

### Technical Field

The present invention relates to a metatitanic acid particle, a composition for forming a photocatalyst, and a photocatalyst.

### SUMMARY

According to an aspect of the invention, there is provided a metatitanic acid particle including bonded thereon a metal-containing compound which has a hydrocarbon group,

wherein the metatitanic acid particle has an absorption at 450 nm and 750 nm in a visible absorption spectrum, and,

with respect to a surface of the particle, an element ratio M/Ti between metal M of the metal-containing compound and titanium is from 0.1 to 0.4 and an element ratio C/Ti between carbon C and titanium is from 0.3 to 1.2.

### DETAILED DESCRIPTION

Hereinafter, an exemplary embodiment which is an example of the invention will be described.

### Metatitanic Acid Particle

A metatitanic acid particle according to an exemplary embodiment is one subjected to surface treatment with a metal-containing compound having a hydrocarbon group. The metatitanic acid particle absorbs light having wavelengths of 450 nm and 750 nm in a visible absorption spectrum. With respect to the surface of the particle, the element ratio M/Ti between metal M of the metal-containing compound and titanium is from 0.1 to 0.4, and the element ratio C/Ti between carbon C and titanium is from 0.3 to 1.2.

The metatitanic acid particle according to the exemplary embodiment is suitably used as a photocatalyst.

The metatitanic acid particle according to the exemplary embodiment has the above configuration, and thus shows a high photocatalyst function even in the visible light region. The reason is estimated as follows.

Firstly, generally, an untreated metatitanic acid particle as a photocatalyst absorbs ultraviolet rays, and thus shows a photocatalyst function (photocatalyst activation). Thus, an untreated metatitanic acid particle has a tendency to enable showing of the photocatalyst function during a daytime on a sunny day on which sufficient ultraviolet rays may be secured, but ultraviolet rays are insufficiently secured and the function is deteriorated during a night-time or in the shade. For example, in a case where an untreated metatitanic acid particle is used as an exterior wall material, a difference in strain resistance may occur in accordance with a sunny place and a shade place. In a case where an untreated metatitanic acid particle is used in an air cleaner, a water purifier, or the like, an additional mounting space, for example, in which a black light and the like which function as a light source of an ultraviolet ray is mounted in the device may be required.

Recently, metatitanic acid particles which show the photocatalyst function (photocatalyst activation) by absorbing visible light are also known. For example, as such a visible light-absorption type metatitanic acid particle, a metatitanic acid particle obtained by adhering a different type of metal (iron, copper, tungsten, and the like) to metatitanic acid, a metatitanic acid particle obtained by doping a nitrogen element, a sulfur element, and the like are known.

A metatitanic acid particle which shows the high photocatalyst function even in a visible light region is required.

For satisfying the requirement, a metatitanic acid particle subjected to surface treatment with a metal-containing compound having a hydrocarbon group is provided. In the metatitanic acid particle, light having wavelengths of 450 nm and 750 nm in a visible absorption spectrum is absorbed, and with respect to the surface of the particle, the element ratio M/Ti between metal M of the metal-containing compound and titanium is from 0.1 to 0.4, and the element ratio C/Ti between carbon C and titanium is from 0.3 to 1.2.

The metatitanic acid particle which satisfies the respective element ratios has a C/Ti element ratio lower than a numerical range of the M/Ti element ratio, in comparison to that of a general metatitanic acid particle subjected to surface treatment with a metal-containing compound having a hydrocarbon group.

The M/Ti element ratio with respect to the surface of the metatitanic acid particle is from 0.1 to 0.4, and thus the quantity of particles subjected to surface treatment with the metal-containing compound is adequate, light having wavelengths of 450 nm and 750 nm is sufficiently absorbed, and the high photocatalyst function is shown in the visible light region.

If the M/Ti element ratio is less than 0.1, an amount of the surface of the metatitanic acid particle coated with the metal-containing compound is small. Thus, sufficient absorption at wavelengths of 450 nm and 750 nm is not obtained, and the photocatalyst function in the visible light region is deteriorated. If the M/Ti element ratio is more than 0.4, the amount of the surface of the metatitanic acid particle coated with the metal-containing compound is large, and an exposed amount to expose a portion of the metatitanic acid particle which metatitanic acid is to be activated is reduced. Thus, the photocatalyst function in the visible light region is deteriorated.

The C/Ti element ratio with respect to the surface of the metatitanic acid particle is from 0.3 to 1.2, and thus an amount of carbon in the hydrocarbon group and the like on the surface of the metatitanic acid particle is adequate. Light having wavelengths of 450 nm and 750 nm is sufficiently absorbed, and the high photocatalyst function is shown in the visible light region.

If the C/Ti element ratio is less than 0.3, the amount of carbon with respect to the surface of the metatitanic acid particle is small. Thus, sufficient absorption at wavelengths of 450 nm and 750 nm is not obtained, and the photocatalyst function in the visible light region is deteriorated. If the C/Ti element ratio is more than 1.2, the amount of hydrocarbon groups on the surface of the metatitanic acid particle is large. Thus, exposed amount of a portion at which metatitanic acid is activated on the surface of the metatitanic acid particle is reduced, and a case where the hydrocarbon group is decomposed by the photocatalyst function also occurs. Accordingly, the photocatalyst function in the visible light region is deteriorated.

Hitherto, with the above configuration, it is estimated that the metatitanic acid particle according to the exemplary embodiment shows the high photocatalyst function even in the visible light region.

For example, regarding the metatitanic acid particle which satisfies each of the element ratios, a metatitanic acid particle subjected to surface treatment with a metal-containing compound having a hydrocarbon group is prepared in such a manner that some of the hydrocarbon groups are oxidized and decomposed by treatment such as heating. Regarding such a metatitanic acid particle, it is considered that hydrocarbon and carbon obtained by carbonizing hydrocarbon are provided in a pore of the metatitanic acid particle, that is, hydrocarbon and carbon obtained by carbonizing hydrocarbon are buried from the surface layer over the inside of the metatitanic acid particle.

It is considered that the buried carbon functions as a charge separation material, and thus the photocatalyst function is shown. It is considered that the carbon operates as an optical charge separation function even by absorbing visible light along with ultraviolet light, and thus the photocatalyst function is shown. This indicates that the metatitanic acid particle absorbs light having wavelengths of 450 nm and 750 nm in the visible absorption spectrum. Further, carbon as the charge separation material has a function of accelerating separation of charges generated by absorbing light, and also acts as a promoter.

That is, the followings are considered. Carbon provided in a pore of the metatitanic acid particle performs an action of selectively accelerating electrons, by absorbing visible light along with ultraviolet light. Thus, carbon as the charge separation material causes a probability of recombining electrons and holes of the metatitanic acid particle, which are excited, by absorbing light to be reduced. The carbon effectively accelerates separation of charges, and this acceleration of separation of charges causes the photocatalyst function to be improved.

Generally, an untreated metatitanic acid particle has a tendency of a low degree of freely controlling a particle diameter, particle diameter distribution, and a shape of a particle, and has a tendency of high particle aggregation. Thus, in resin, dispersibility of metatitanic acid particles in a liquid is deteriorated, and there is a tendency that (1) showing of the photocatalyst function is difficult and (2) transparency of a film and the like and uniformity of a coated film of a coating liquid is easily deteriorated.

However, since the metatitanic acid particle according to the exemplary embodiment has a hydrocarbon group on the surface thereof, dispersibility of primary particles in a coated film is also secured. Thus, a coated film may be substantially uniformly formed, and light hits the metatitanic acid particle with high efficiency, and thus the photocatalyst function is easily shown. Transparency of a film and the like, uniformity of a coated film of a coating liquid, and high design properties are held together. As a result, for example, when a coating material containing the metatitanic acid particle is applied onto the surface of an outer wall material, a plate, a pipe, or non-woven fabric (non-woven fabric of ceramic and the like), aggregation of metatitanic acid particles and an occurrence of coating defects are prevented, and the photocatalyst function is easily shown for a long term.

Details of the metatitanic acid particle according to the exemplary embodiment will be described below.

### Untreated Metatitanic Acid Particle

An untreated metatitanic acid particle (metatitanic acid particle which is a target of surface treatment) refers to a particle of titanic acid which satisfies n=1 among titanic acid hydrates TiO₂.nH₂O.

The untreated metatitanic acid particle in the exemplary embodiment is a metatitanic acid particle which is not subjected to surface treatment with a metal-containing compound having a hydrocarbon group. The surface treatment may include any type of surface treatment. However, it is preferable that the metatitanic acid particle according to the exemplary embodiment is a metatitanic acid particle subjected to surface treatment with only a metal-containing compound having a hydrocarbon group.

A preparing method of the untreated metatitanic acid particle is not particularly limited. However, a chlorine method (vapor phase method) , and a sulfuric acid method (liquid phase method) are exemplified.

An example of the chlorine method (vapor phase method) is as follows. Firstly, rutile ore which is a raw material is caused to react with coke and chlorine. After the reactant is exposed to gaseous titanium tetrachloride once, cooling is performed, thereby a titanium tetrachloride liquid is obtained. Then, titanium tetrachloride is dissolved in water, and hydrolysis is caused while a strong base is put into the water in which titanium tetrachloride is dissolved. Thus, an untreated metatitanic acid [titanium oxyhydroxide (TiO(OH)₂)] particle is obtained.

An example of the sulfuric acid method (liquid phase method) is as follows. Firstly, ilmenite ore (FeTiO₃) or titanium slag which is a raw material is dissolved in concentrated sulfuric acid, and an iron component which is an impurity is separated in a form of iron sulfate (FeSO₄), so that titanium oxysulfate (TiOSO₄) is obtained (a titanyl sulfate solution). Then, titanium oxysulfate (TiOSO₄) is subjected to hydrolysis, and thus an untreated metatitanic acid [titanium oxyhydroxide (TiO(OH)₂)] particle is obtained.

### Metal-Containing Compound

The metal-containing compound according to the exemplary embodiment has a hydrocarbon group.

Examples of the hydrocarbon group included in the metal-containing compound include an aliphatic hydrocarbon group and an aromatic hydrocarbon group, each having 1 to 40 carbon atoms (preferably 1 to 18 carbon atoms, more preferably 4 to 12 carbon atoms, and further preferably 4 to 10 carbon atoms) and being saturated or unsaturated.

The hydrocarbon group may or may not be directly combined to metal in the metal-containing compound. However, from a viewpoint of showing a high photocatalyst function and improving dispersiblity, the hydrocarbon group is preferably directly combined.

As metal of the metal-containing compound having the hydrocarbon group, a metal atom selected from the group consisting of silicon and aluminum is preferable, and silicon is particularly preferable. That is, as the metal-containing compound having a hydrocarbon group, a silane compound having a hydrocarbon group is particularly preferable.

Examples of the silane compound include a chlorosilane compound, an alkoxysilane compound, a silazane compound (hexamethyldisilazane and the like).

Among these substances, from a viewpoint of showing a high photocatalyst function and improving dispersiblity, a compound represented by a formula of R¹ₙSiR²ₘ is preferable as the silane compound.

In the formula of R¹ₙSiR²ₘ, R¹ represents an aliphatic hydrocarbon group or an aromatic hydrocarbon group each having 1 to 20 carbon atoms and being saturated or unsaturated, R² represents a halogen atom or an alkoxy group, n represents an integer of 1 to 3, and m represents an integer of 1 to 3, provided that n+m =4 is satisfied. In a case where n represents an integer of 2 or 3, plural R¹s may be the same or different. In a case where m represents an integer of 2 or 3, plural R²s may be the same or different.

The aliphatic hydrocarbon group represented by R¹ may have any of a straight chain shape, a branched chain shape, and a ring shape. However, from a viewpoint of dispersiblity, a straight chain shape or a branched chain shape is preferable, and a straight chain shape is more preferable. From a viewpoint of showing a high photocatalyst function and improving dispersibility, the aliphatic hydrocarbon group has preferably from 1 to 18 carbon atoms, more preferably from 4 to 12 carbon atoms, and further preferably from 4 to 10 carbon atoms. The aliphatic hydrocarbon group may be a saturated or unsaturated aliphatic hydrocarbon group. However, from a viewpoint of showing a high photocatalyst function and improving dispersibility, a saturated aliphatic hydrocarbon group is preferable, and an alkyl group is more preferable.

Examples of the saturated aliphatic hydrocarbon group include a straight-chain alkyl group (a methyl group, an ethyl group, a propyl group, a butyl group, a pentyl group, a hexyl group, a heptyl group, an octyl group, a nonyl group, a decyl group, a dodecyl group, a hexadecyl group, an icosyl group, and the like); a branched chain alkyl group (an isopropyl group, an isobutyl group, an isopentyl group, a neopentyl group, a 2-ethylhexyl group, a tertiary butyl group, a tertiary pentyl group, an isopentadecyl group, and the like); and a cyclic alkyl group (a cyclopropyl group, a cyclopentyl group, a cyclohexyl group, a cycloheptyl group, a cyclooctyl group, a tricyclodecyl group, a norbornyl group, an adamantyl group, and the like).

Examples of the unsaturated aliphatic hydrocarbon group include an alkenyl group (a vinyl group (ethenyl group), a 1-propenyl group, a 2-propenyl group, a 2-butenyl group, a 1-butenyl group, a 1-hexenyl group, a 2-dodecenyl group, a pentenyl group, and the like); and an alkynyl group (an ethynyl group, a 1-propynyl group, a 2-propynyl group, a 1-butynyl group, a 3-hexynyl group, a 2-dodecynyl group, and the like).

The aliphatic hydrocarbon group also includes a substituted aliphatic hydrocarbon group. Examples of a substituent which may be substituted with the aliphatic hydrocarbon group include an epoxy group, a mercapto group, a methacryloyl group, and an acryloyl group.

As the aromatic hydrocarbon group represented by R¹, an aromatic hydrocarbon group having 6 to 27 carbon atoms (preferably 6 to 18) is exemplified.

Examples of the aromatic hydrocarbon group include a phenylene group, a biphenylene group, a terphenylene group, a naphthalene group, and an anthracene group.

The aromatic hydrocarbon group also includes a substituted aromatic hydrocarbon group. Examples of a substituent which may be substituted with the aromatic hydrocarbon group include an epoxy group, a glycidyl group, a mercapto group, a methacryloyl group, and an acryloyl group.

Examples of the halogen atom represented by R² include a fluorine atom, a chlorine atom, a bromine atom, and an iodine atom. Among these atoms, as the halogen atom, a chlorine atom, a bromine atom, or an iodine atom is preferable.

Examples of the alkoxy group represented by R² include an alkoxy group having 1 to 10 carbon atoms (preferably 1 to 8, and more preferably 3 to 8).

Examples of the alkoxy group include a methoxy group, an ethoxy group, an isopropoxy group, a t-butoxy group, a n-butoxy group, a n-hexyloxy group, a 2-ethylhexyloxy group, and a 3,5,5-trimethylhexyloxy group.

The alkoxy group also includes a substituted alkoxy group. Examples of a substituent which may be substituted with the alkoxy group include a halogen atom, a hydroxyl group, an amino group, an alkoxy group, an amide group, and a carbonyl group.

As the compound represented by the formula of R¹ₙSiR²ₘ, a compound in which R¹ represents a saturated hydrocarbon group is preferable from a viewpoint of showing a high photocatalyst function and improving dispersibility. In particular, as the compound represented by the formula of R¹ₙSiR²ₘ, a compound in which R¹ represents a saturated aliphatic hydrocarbon group having 1 to 20 carbon atoms, R² represents a halogen atom or an alkoxy group, n represents an integer of 1 to 3, and m represents an integer of 1 to 3 (n+m=4 is satisfied) is preferable.

Specific examples of the compound represented by the formula of R¹ₙSiR²ₘ include vinyltrimethoxysilane, propyl trimethoxysilane, i-butyltrimethoxysilane, n-butyltrimethoxysilane, n-hexyltrimethoxysilane, n-octyltrimethoxysilane, n-dodecyltriethoxysilane, phenyltrimethoxysilane, 3-glycidoxypropyltrimethoxysilane, tetramethoxysilane, methyltrimethoxysilane, dimethyl dimethoxysilane, diphenyldimethoxysilane, o-methylphenyltrimethoxysilane, p-methylphenyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyl triethoxysilane, γ-methacryloxypropyltrimethoxysilane, γ-glycidyloxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl) aminopropyltrimethoxysilane, and γ-(2-aminoethyl) aminopropylmethyldimethoxysilane.

The silane compound may be singly used or may be used in combination of two types or more.

Among these substances, from a viewpoint of showing a high photocatalyst function and improving dispersiblity, the hydrocarbon group in the silane compound is preferably an aliphatic hydrocarbon group, more preferably a saturated aliphatic hydrocarbon group, and particularly preferably an alkyl group.

From a viewpoint of showing a high photocatalyst function and improving dispersiblity, the hydrocarbon group in the silane compound has preferably 1 to 18 carbon atoms, more preferably 4 to 12 carbon atoms, and particularly preferably 4 to 10 carbon atoms.

Examples of an aluminum compound in which a metal atom of the metal-containing compound is Aland a hydrocarbon group is provided include alkyl aluminate such as triethoxyaluminum, tri-i-propoxyaluminum, and tri-sec-butoxyaluminum; aluminum chelate such as di-i-propoxy-mono-sec-butoxyaluminum, and di-i-propoxyaluminum-ethylacetoacetate; and an aluminum coupling agent such as acetoalkoxyaluminum diisopropylate.

### Characteristics of Metatitanic Acid Particle

The metatitanic acid particle according to the exemplary embodiment absorbs light having wavelengths of 450 nm and 750 nm in a visible absorption spectrum.

From a viewpoint of showing a high photocatalyst function even in the visible light region, it is preferable that the metatitanic acid particle according to the exemplary embodiment absorbs light having wavelengths of 450 nm, 600 nm, and 750 nm in the visible absorption spectrum. It is more preferable that the metatitanic acid particle absorbs light having a range of a wavelength of 450 nm to 750 nm in the visible absorption spectrum. It is particularly preferable that the metatitanic acid particle absorbs light having a range of a wavelength of 400 nm to 800 nm in the visible absorption spectrum.

Regarding the metatitanic acid particle, from a viewpoint of showing a high photocatalyst function even in the visible light region, in an ultraviolet-visible absorption spectrum, when absorbance at a wavelength of 350 nm is set to 1, the absorbance at a wavelength of 450 nm is preferably equal to or more than 0.02 (preferably equal to or more than 0.1). In addition, it is more preferable that absorbance at a wavelength of 450 nm is equal to or more than 0.2 (preferably equal to or more than 0.3), and absorbance at a wavelength of 750 nm is equal to or more than 0.02 (preferably equal to or more than 0.1).

The ultraviolet-visible absorption spectrum is measured by a method as follows. Firstly, metatitanic acid particles which are a measurement target are dispersed in tetrahydrofuran, and then are applied onto a glass substrate. Then, drying is performed at 24° C. in the air. Regarding measurement, the measurement is performed in diffuse reflection arrangement, and ideal absorbance is obtained by Kubelka-Munk conversion. Regarding a diffusion reflection spectrum, measurement is performed in a range of a wavelength of 200 nm to 900 nm by using reflectance, and by using a spectrophotometer (U-4100 manufactured by Hitachi High-Technologies Corporation) [measurement under measurement conditions; a scan speed of 600 nm, a slit width of 2 nm, a sampling interval of 1 nm, and total reflectance measurement mode]. Then, Kubelka-Munk conversion is performed, thereby a visible absorption spectrum is obtained.

Regarding the metatitanic acid particle according to the exemplary embodiment, the M/Ti element ratio with respect to the surface is 0.1 to 0.4, and the C/Ti element ratio with respect to the surface is 0.3 to 1.2.

Specifically, for example, from a viewpoint of showing a high photocatalyst function even in the visible light region, the metatitanic acid particle has an M/Ti element ratio with respect to the surface, which is preferably 0.15 to 0.36, and more preferably 0.17 to 0.33.

From a viewpoint of showing a high photocatalyst function even in the visible light region, the metatitanic acid particle has a C/Ti element ratio with respect to the surface, which is preferably 0.4 to 1.1, more preferably 0.5 to 1.0, and particularly preferably 0.6 to 0.9.

From a viewpoint of showing a high photocatalyst function even in the visible light region, regarding the metatitanic acid particle, it is preferable that the element ratio O/(M+Ti) between oxygen O and the total of the metal M and titanium is from 2.05 to 2.5. The ratio thereof is more preferably 2.1 to 2.45, and further preferably 2.15 to 2.4.

On the surface of a metatitanic acid particle generally subjected to surface treatment with a metal-containing compound having a hydrocarbon group, the element ratio O/(M+Ti) between oxygen O and the total of the metal M and titanium indicates 2.0 or a value which is slightly lower than 2.0. However, the metatitanic acid particle according to the exemplary embodiment has a strong tendency that the value of O/(M+Ti) with respect to the surface of the metatitanic acid particle is 2.05 to 2.5. It is considered that this means that hydrocarbon groups on the surface of the metatitanic acid particle are adequately carbonized. Thus, the metatitanic acid particle sufficiently absorbs light having wavelengths of 450 nm and 750 nm, and shows a high photocatalyst function in the visible light region.

If the O/(M+Ti) element ratio is less than 2.05, the hydrocarbon groups on the surface of the metatitanic acid particle may be not sufficiently carbonized, and high absorption at wavelengths of 450 nm and 750 nm may be not performed. In addition, the photocatalyst function may be insufficiently shown in the visible light region. If the O/(M+Ti) element ratio is more than 2.5, many of O atoms are provided on the surface of the metatitanic acid particle. Thus, an exposed amount of a portion at which metatitanic acid is activated on the surface of the metatitanic acid particle may be reduced, and the photocatalyst function may be insufficiently shown in the visible light region.

The M/Ti element ratio, the C/Ti element ratio, and the value of O/(M+Ti) with respect to the surface of the metatitanic acid particle are measured by a method as follows. Firstly, measurement is performed on a metatitanic acid particle which is a measurement target. The measurement is performed by means of an X-ray photoelectron spectroscopy (XPS) analyzer (JPS-9000MX manufactured by JEOL Corp.) under conditions that a MgKα beam is used as an X-ray source, an acceleration voltage is set to 10 kV, and an emission current is set to 20 mA. The M/Ti element ratio, the C/Ti element ratio, and the value of O/(M+Ti) are calculated from intensity of a peak of each element.

The volume average particle diameter of the metatitanic acid particles according to the exemplary embodiment is preferably 10 nm to 1 μm, more preferably 10 nm to 200 nm, and further preferably 15 nm to 200 nm.

If the volume average particle diameter of the metatitanic acid particles is equal to or more than 10 nm, the metatitanic acid particles are unlikely to cause aggregation, and the photocatalyst function is easily highly shown. If the volume average particle diameter of the metatitanic acid particles is set to be equal to or less than 1 μm, a percentage of a specific surface area to an amount is increased, and the photocatalyst function is easily highly shown. Thus, if the volume average particle diameter of the metatitanic acid particles is set to be in the above range, a high photocatalyst function is easily shown in the visible light region.

The volume average particle diameter of the metatitanic acid particles is measured by NANOTRACK UPA-ST (a dynamic light scattering type particle diameter measuring device manufactured by Microtrac Bel). Regarding a measurement condition, the concentration of a sample is set to be 20%, and the measurement period is set to be 300 seconds. This device measures a particle diameter by utilizing a Brownian motion of dispersoid. The device irradiates a solution with a laser beam, and detects scattered light, so as to measure a particle diameter.

Cumulative distribution of a volume of each particle from a small particle diameter side, in a divided particle diameter range (channel) is drawn based on particle diameter distribution which is measured by a dynamic light scattering type particle diameter measuring device. Then, a particle diameter causing the accumulation to be 50% is obtained as a volume average particle diameter.

### Preparing Method of Metatitanic Acid Particle

A preparing method of the metatitanic acid particle according to the exemplary embodiment is not particularly limited. However, it is preferable that the preparing method includes performing surface treatment on an untreated metatitanic acid particle with a metal-containing compound having a hydrocarbon group, and heating the metatitanic acid particle during or after the process of performing surface treatment on the untreated metatitanic acid particle.

Firstly, surface treatment of an untreated metatitanic acid particle with a metal-containing compound will be described.

A method of performing surface treatment on an untreated metatitanic acid particle with a metal-containing compound is not particularly limited. For example, a method in which a metal-containing compound itself is brought into contact with an untreated metatitanic acid particle, and a method in which a treatment liquid in which the metal-containing compound is dissolved in a solvent is brought into contact with an untreated metatitanic acid particle are exemplified. Specifically, for example, a method in which a metal-containing compound itself or the treatment liquid is added to a dispersion in which untreated metatitanic acid particles are dispersed in a solvent, under stirring, and a method in which the addition (dropping, ejecting, and the like) to an untreated metatitanic acid particle in a state of flowing by stirring of HENSCHEL MIXER and the like is performed are exemplified.

With the above method, a reactive group (for example, a hydrolyzable group) of the metal-containing compound reacts with a hydrolyzable group (a hydroxyl group, a halogeno group, an alkoxy group, and the like) being provided on the surface of an untreated metatitanic acid particle, and thus the surface treatment of the untreated metatitanic acid particle with the metal-containing compound is performed.

Here, examples of a solvent for dissolving the metal-containing compound include an organic solvent (for example, a hydrocarbon solvent, an ester solvent, an ether solvent, a halogen solvent, and an alcohol solvent), water, and a solvent mixture thereof.

Examples of the hydrocarbon solvent include toluene, benzene, xylene, hexane, octane, hexadecane, and cyclohexane. Examples of the ester solvent include methyl acetate, ethyl acetate, isopropyl acetate, and amyl acetate. Examples of the ether solvent include dibutyl ether and dibenzyl ether. Examples of the halogen solvent include 1,1-dichloro-1-fluoroethane, 1,1-dichloro-2,2,2-trifluoroethane, 1,1-dichloro-2,2,3,3,3-pentafluoropropane, chloroform, dichloroethane, and carbon tetrachloride. Examples of the alcohol solvent include methanol, ethanol, and i-propyl alcohol. Examples of the water include tap water, distilled water, and pure water.

As the solvent, in addition to the above solvents, a solvent such as dimethylformamide, dimethylacetamide, dimethylsulfoxide, acetic acid, and sulfuric acid may be used.

In the treatment liquid in which the metal-containing compound is dissolved in a solvent, the concentration of the metal-containing compound is preferably 0.05 mol/L to 500 mol/L, and more preferably 0.5 mol/L to 10 mol/L.

Regarding the condition for surface treatment of a metatitanic acid particle with the metal-containing compound, from a viewpoint of showing a high photocatalyst function and improving dispersiblity, the following conditions may be provided. An untreated metatitanic acid particle may be preferably subjected to surface treatment with a metal-containing compound in an amount of 10% by weight to 100% by weight (preferably, 20% by weight to 75% by weight, and more preferably 25% by weight to 50% by weight) with respect to the untreated metatitanic acid particle. If the treated amount of the metal-containing compound is set to be equal to or more than 10% by weight, a high photocatalyst function is easier shown in the visible light region. The dispersiblity is also easily improved. If the treated amount of the metal-containing compound is set to be equal to or less than 100% by weight, an occurrence of a situation in which an amount of metal (M) on the surface (Ti—O—) of the metatitanic acid particle is excessive is prevented, and deterioration of the photocatalyst function by surplus metal (M) is easily prevented.

The temperature for the surface treatment of an untreated metatitanic acid particle with the metal-containing compound is preferably 15° C. to 150° C., and more preferably 20° C. to 100° C. The surface treatment time is preferably 10 minutes to 120 minutes, and more preferably 30 minutes to 90 minutes.

After the surface treatment of an untreated metatitanic acid particle with the metal-containing compound, drying treatment may be performed. A method of the drying treatment is not particularly limited. For example, a known drying method such as a vacuum drying method and a spray drying method may be used. The drying temperature is preferably 20° C. to 150° C.

Next, heating treatment will be described.

The heating treatment may be performed in the middle of the process of performing surface treatment on an untreated metatitanic acid particle or after the process of performing surface treatment on an untreated metatitanic acid particle. Specifically, when an untreated metatitanic acid particle is surface-treated with the metal-containing compound, when drying treatment after surface treatment is performed, or after drying treatment, the heating treatment may be separately performed. However, because the metatitanic acid particle is required to sufficiently react with the metal-containing compound before the heating treatment is performed, when drying treatment after surface treatment is performed or after the drying treatment, the heating treatment is preferably separately performed. It is more preferable that the drying treatment is performed, and then the heating treatment is separately performed in a state where surface treatment and drying of the metatitanic acid particle is adequately performed.

From a viewpoint of showing a high photocatalyst function and improving dispersibility, a temperature of the heating treatment is preferably 180° C. to 500° C., more preferably 200° C. to 450° C., and further preferably 250° C. to 400° C.

In a case where heating treatment is performed in the middle of the process of performing surface treatment on an untreated metatitanic acid particle, the metal-containing compound is caused to perform sufficient reaction at the temperature of the surface treatment performed ahead, and then, heating treatment is performed at the temperature of the heating treatment. In a case where heating treatment is performed in drying treatment after surface treatment, the temperature of the drying treatment is used as the temperature of the heating treatment.

From a viewpoint of showing a high photocatalyst function and improving dispersibility, a period for the heating treatment is preferably 10 minutes to 300 minutes, and more preferably 30 minutes to 120 minutes.

The method of the heating treatment is not particularly limited. A known heating method, for example, heating by an air furnace, a kiln (roller hearth kiln, shuttle kiln, and the like), a radiant heating furnace, and the like, heating by a laser beam, an infrared ray, UV, a microwave, and the like is used.

Through the above processes, the metatitanic acid particle according to the exemplary embodiment is appropriately obtained.

### Composition for Forming Photocatalyst

A composition for forming a photocatalyst according to the exemplary embodiment contains the metatitanic acid particle according to the exemplary embodiment and at least one compound selected from the group consisting of a dispersion medium and a binder.

Examples of a form of the composition for forming a photocatalyst according to the exemplary embodiment include a dispersion which contains the metatitanic acid particle according to the exemplary embodiment and a dispersion medium, and a composition which contains the metatitanic acid particle according to the exemplary embodiment, and an organic or inorganic binder.

The dispersion may have a paste shape having high viscosity.

As the dispersion medium, water, an organic solvent, and the like are preferably used.

Examples of the water include tap water, distilled water, and pure water.

The organic solvent is not particularly limited, and for example, a hydrocarbon solvent, an ester solvent, an ether solvent, a halogen solvent, and an alcohol solvent are exemplified.

From a viewpoint of dispersion stability and storage stability, the dispersion preferably contains at least one type of compound selected from the group consisting of a dispersing agent and a surfactant. As the dispersing agent and the surfactant, well-known materials are used.

The binder used in the composition is not particularly limited. Examples of the binder include fluorine resin, silicone resin, polyester resin, acrylic resin, styrene resin, acrylonitrile/styrene copolymer resin, acrylonitrile/butadiene/styrene copolymer (ABS) resin, epoxy resin, polycarbonate resin, polyamide resin, polyamine resin, polyurethane resin, polyether resin, polysulfide resin, polyphenol resin, a compound thereof, an organic binder such as resin obtained by silicone-modifying or halogen-modifying the above resins, and an inorganic binder such as a glass, ceramic, metal powder.

The dispersion may contain the binder in a form of an emulsion.

The composition for forming a photocatalyst according to the exemplary embodiment may contain other components other than the above-described components.

Well-known additives are used as the other components, for example, a promoter, a coloring agent, a filler, an antiseptic agent, a defoaming agent, an adhesion-enhancing agent, and a thickening agent are exemplified.

The composition for forming a photocatalyst according to the exemplary embodiment may singly contain the metatitanic acid particle according to the exemplary embodiment or may contain two types or more of metatitanic acid particles.

In the composition for forming a photocatalyst according to the exemplary embodiment, the content of the metatitanic acid particle according to the exemplary embodiment is not particularly limited, and may be appropriately selected in accordance with various forms such as a dispersion and a resin composition, and a desired amount of the photocatalyst.

A preparing method of a photocatalyst using the composition for forming a photocatalyst according to the exemplary embodiment, or a preparing method of a structure having the photocatalyst are not particularly limited, and well-known applying methods are used.

Examples of the applying method of the composition for forming a photocatalyst according to the exemplary embodiment include a spin coating method, a dip coating method, a flow coating method, a spray coating method, a roll coating method, a brush coating method, a sponge coating method, a screen printing method, and an ink jet printing method.

### Photocatalyst and Structure

The photocatalyst according to the exemplary embodiment contains or is formed of the metatitanic acid particle according to the exemplary embodiment.

A structure according to the exemplary embodiment contains the metatitanic acid particle according to the exemplary embodiment.

The photocatalyst according to the exemplary embodiment may be a photocatalyst formed from only the metatitanic acid particle according to the exemplary embodiment, a photocatalyst obtained by mixing a promoter to the metatitanic acid particle according to the exemplary embodiment, or a photocatalyst obtaining by fixing the metatitanic acid particle according to the exemplary embodiment to a desired shape by using an adhesive or a pressure-sensitive adhesive.

From a viewpoint of photocatalyst activation, the structure according to the exemplary embodiment preferably has the metatitanic acid particle according to the exemplary embodiment, on a surface thereof at least.

The structure according to the exemplary embodiment preferably has the metatitanic acid particle according to the exemplary embodiment, as a photocatalyst.

The structure according to the exemplary embodiment is preferably a structure in which at least the metatitanic acid particle according to the exemplary embodiment is provided at at least a portion of the surface of a base material, and is preferably a structure formed by applying the composition for forming a photocatalyst according to the exemplary embodiment, to at least a portion of the surface of the base material.

In the structure, the amount of the applied composition for forming a photocatalyst according to the exemplary embodiment is not particularly limited, and may be selected in accordance with a desire.

Further, in the structure according to the exemplary embodiment, the metatitanic acid particle according to the exemplary embodiment may be adhered or fixed to the surface of the base material. However, from a viewpoint of durability of the photocatalyst, the metatitanic acid particle is preferably fixed to the surface of the base material. A fixing method is not particularly limited, and well-known fixing methods are used.

As a base material used in the exemplary embodiment, various materials are exemplified regardless of an inorganic material and an organic material. The shape of the base material is also not limited.

Preferable examples of the base material include metal, ceramic, glass, plastic, rubber, stone, cement, concrete, textile, fabric, wood, paper, and combination thereof, a stacked member, and an object having at least one coated film on the surface thereof.

Examples of the base material which is preferable from a viewpoint of a use include a building material, an exterior material, a window frame, window glass, a mirror, a table, dishes, a curtain, lens, a prism, exterior and painting of a vehicle, exterior of a mechanical device or a product, a dustproof cover and painting, a traffic sign, various display devices, an advertising tower, a sound insulation wall for road, a sound insulation wall for railway, a bridge, exterior and painting of a guard rail, interior and painting of a tunnel, an insulator, a solar cell cover, a solar water heater collector cover, a polymer film, a polymer sheet, a filter, an indoor signboard, an outdoor signboard, a vehicle lighting lamp cover, an outdoor lighting equipment, an air purifier, a water purifier, medical equipment, and a nursing care product.

### EXAMPLES

The present invention will be more specifically described by using examples. However, the examples do not limit the present invention. “A part” or “%” indicates a weight basis as long as particular statement is not made.

### Example 1

### Preparation of Metatitanic Acid Slurry

Into a titanyl sulfate solution having a TiO₂ concentration of 260 g/L and a Ti³⁺ concentration of 6.0 g/L in terms of TiO₂ conversion, an anatase seed which is separately prepared and is 8% by weight with respect to TiO₂ in a titanyl sulfate solution in terms of TiO₂ conversion is added. Then, this solution is heated at a temperature higher than a boiling point, so as to perform hydrolysis of titanyl sulfate (TiOSO₄), and thus particulate metatitanic acid is formed. Then, the formed metatitanic acid particle is filtered and washed. Then, a slurry is formed, and the slurry is neutralized and washed at pH 7. In this manner, a metatitanic acid slurry having a volume average particle diameter of 40 nm is obtained.

### Preparation of Metatitanic Acid Particle

A 5 N aqueous sodium hydroxide solution is added to the metatitanic acid slurry having a volume average particle diameter of 40 nm, with stirring, and thus pH thereof is set to 8.5, and the slurry is stirred and held for two hours. Then, the slurry is neutralized to pH 5.8 by using a 6N hydrochloric acid, filtered, and washed with water. After washing, further water is added so as to form a slurry. A 6 N hydrochloric acid is added to the slurry so as to have pH 1.3, with stirring. Then, the slurry is stirred and held for three hours. 100 parts in terms of metatitanic acid are collected from the slurry, and are heated and held at 60° C. Then, 40 parts of isobutyltrimethoxysilane are added thereto with stirring, and are stirred and held for 30 minutes. Then, a 7 N aqueous sodium hydroxide solution is added thereto to perform neutralization to pH 7. Then, filtration and washing is performed. The residue obtained after the filtration and water washing is ejected and dried under a condition of an outer port temperature of 150° C., by an air dryer. Thus, dry powder is obtained.

Heating treatment is performed on the obtained dry powder in an electric furnace at 400° C. for one hour, and thus a metatitanic acid particle 1 is obtained.

### Example 2

A metatitanic acid particle 2 is obtained in the same manner as in Example 1 except that isobutyltrimethoxysilane in Example 1 is changed to hexyltrimethoxysilane.

### Example 3

A metatitanic acid particle 3 is obtained in the same manner as in Example 1 except that isobutyltrimethoxysilane in Example 1 is changed to decyltrimethoxysilane.

### Example 4

A metatitanic acid particle 4 is obtained in the same manner as in Example 2 except that an added amount of hexyltrimethoxysilane in Example 2 is changed from 40 parts to 50 parts.

### Example 5

A metatitanic acid particle 5 is obtained in the same manner as in Example 2 except that the temperature in the electric furnace when dried particulate powder in Example 2 is heated is changed from 400° C. to 250° C.

### Example 6

A metatitanic acid particle 6 is obtained in the same manner as in Example 1 except that the temperature in the electric furnace when dried particulate powder in Example 1 is heated is changed from 400° C. to 500° C.

### Example 7

A metatitanic acid particle 7 is obtained in the same manner as in Example 2 except that an added amount of hexyltrimethoxysilane in Example 2 is changed from 40 parts to 25 parts.

### Example 8

A metatitanic acid particle 8 is obtained in the same manner as in Example 2 except that an added amount of hexyltrimethoxysilane in Example 2 is changed from 40 parts to 75 parts.

### Example 9

A metatitanic acid particle 9 is obtained in the same manner as in Example 1 except that 40 parts of isobutyltrimethoxysilane in Example 1 is changed to 35 parts of octyltrimethoxysilane.

### Example 10

A metatitanic acid particle 10 is obtained in the same manner as in Example 1 except that isobutyltrimethoxysilane in Example 1 is changed to methyltrimethoxysilane.

### Example 11

A metatitanic acid particle 11 is obtained in the same manner as in Example 1 except that isobutyltrimethoxysilane in Example 1 is changed to hexamethyldisilazane.

### Example 12

A metatitanic acid particle 12 is obtained in the same manner as in Example 1 except that 40 parts of isobutyltrimethoxysilane in Example 1 are changed to 30 parts of dodecyltrimethoxysilane.

### Example 13

A metatitanic acid particle 13 is obtained in the same manner as in Example 1 except that isobutyltrimethoxysilane in Example 1 is changed to phenyltrimethoxysilane.

### Example 14

A metatitanic acid particle 14 is obtained in the same manner as in Example 1 except that an added amount of isobutyltrimethoxysilane in Example 1 is changed from 40 parts to 10 parts.

### Example 15

A metatitanic acid particle 15 is obtained in the same manner as in Example 2 except that the temperature in the electric furnace when dried particulate powder in Example 2 is heated is changed from 400° C. to 180° C.

### Example 16

A metatitanic acid particle 16 is obtained in the same manner as in Example 2 except that the volume average particle diameter of the metatitanic acid slurry in Example 2 is changed from 40 nm to 12 nm.

### Example 17

A metatitanic acid particle 17 is obtained in the same manner as in Example 2 except that the volume average particle diameter of the metatitanic acid slurry in Example 2 is changed from 40 nm to 980 nm.

### Example 18

A metatitanic acid particle 18 is obtained in the same manner as in Example 2 except that the volume average particle diameter of the metatitanic acid slurry in Example 2 is changed from 40 nm to 6 nm.

### Example 19

A metatitanic acid particle 19 is obtained in the same manner as in Example 2 except that the volume average particle diameter of the metatitanic acid slurry in Example 2 is changed from 40 nm to 1,100 nm.

### Example 20

A metatitanic acid particle 20 is obtained in the same manner as in Example 1 except that isobutyltrimethoxysilane in Example 1 is changed to acetoalkoxyaluminum diisopropylate (AL-M, manufactured by Ajinomoto Co., Inc., an alkoxy group in acetoalkoxy is an oxadecyloxy group).

### Comparative Example 1

A commercial anatase type titanium oxide particle (“SSP-20 (manufactured by Sakai Chemical Industry Co., Ltd.”, volume average particle diameter of 12 nm)) itself is used as a titanium oxide particle C1.

### Comparative Example 2

A commercial rutile type titanium oxide particle (“STR-100N (manufactured by Sakai Chemical Industry Co., Ltd.”, volume average particle diameter of 16 nm)) itself is used as a titanium oxide particle C2.

### Comparative Example 3

The commercial anatase type titanium oxide particle (“SSP-20 (manufactured by Sakai Chemical Industry Co., Ltd.”, volume average particle diameter of 12 nm)) is heated at 400° C. in an electric furnace for one hour, thereby a titanium oxide particle C3 is obtained.

### Comparative Example 4

The commercial rutile type titanium oxide particle (“STR-100N (manufactured by Sakai Chemical Industry Co., Ltd.”, volume average particle diameter of 16 nm)) is heated at 400° C. in an electric furnace for one hour, thereby a titanium oxide particle C4 is obtained.

### Comparative Example 5

A metatitanic acid particle C5 is obtained in the same manner as in Example 1 except that an added amount of isobutyltrimethoxysilane in Example 1 is changed from 40 parts to 5 parts.

### Comparative Example 6

A metatitanic acid particle C6 is obtained in the same manner as in Example 1 except that an added amount of isobutyltrimethoxysilane in Example 1 is changed from 40 parts to 120 parts.

### Comparative Example 7

A metatitanic acid particle C7 is obtained in the same manner as in Example 1 except that the temperature in the electric furnace when dried particulate powder in Example 1 is heated is changed from 400° C. to 600° C.

### Comparative Example 8

A metatitanic acid particle C8 is obtained in the same manner as in Example 1 except that the temperature in the electric furnace when dried particulate powder in Example 1 is heated is changed from 400° C. to 160° C.

### Comparative Example 9

A metatitanic acid particle C9 is obtained in the same manner as in Example 1 except that dried particulate powder in Example 1 is not heated.

### Measurement

Regarding particles obtained in the examples, ultraviolet-visible absorption spectrum characteristics are confirmed. The particles in Examples 1 to 20 and Comparative Examples 5 to 7 absorb light in a range of a wavelength of 400 nm to 800 nm. Items marked as “UV-Vis characteristics” in Table 1 indicate absorbance of a wavelength of 450 nm, a wavelength of 600 nm, and a wavelength of 750 nm, respectively, when absorbance of a wavelength of 350 nm is taken as 1. The M/Ti element ratio, the C/Ti element ratio, and the value of O/(M+Ti) on the surface of the particle by XPS, and the volume average particle diameter (in Table, marked as “D50v”) are measured in accordance with the above-described methods.

### Evaluation

### Decomposing Ability (Photocatalyst Activation)

Decomposing ability is evaluated as photocatalyst characteristics in the visible light region.

Regarding evaluation of the decomposing ability, evaluation is performed through decomposition (chromaticity variation) of a fountain pen ink (INK-30-R manufactured by Pilot Corporation). Specifically, the particles obtained in each of the examples are dispersed in pure water containing 4 parts by weight of methanol, so as to provide a solid concentration of 2 parts by weight. Then, the dispersion is ejected and applied onto a tile (5 cm square). Then, the resultant tile is dried, and thus sample particles are uniformly adhered to the surface of the tile.

Then, a diluted ink obtained by diluting a fountain pen ink 15 times in a liquid mixture of methanol and pure water (methanol: pure water=3:5) is ejected and applied onto the surface thereof. Then, the tile is dried, and thus a sample piece is prepared.

A test piece just after the test piece is prepared is continuously irradiated with visible light (10,000 LX (LUX)) for two hours by using a light emitting diode (LED) which performs irradiation with visible light having a wavelength of 400 nm to 800 nm (while cutting an absorption wavelength region of the ink (wavelength of 450 nm to 550 nm) by a filter). At this time, a 5-yen coin is disposed at the center portion of the irradiated surface of the test piece, and thus a blocked portion of irradiation is formed.

Just after the test piece is prepared and after irradiation with visible light for two hours, hue of the test piece is measured by a spectral color difference meter “RM200QC (manufactured by X-Rite Inc.)”, and ΔE1 and ΔE2 calculated by the following expression are obtained.

Chromaticity E is a value calculated by an expression of E={(L*)²+(a*)²+(b*)²}^{0.5}. Each of L*, a*, and b* indicates a value based on an L*a*b* color system.

ΔE1=(chromaticity of the irradiated surface after continuous irradiation with visible light for two hours)−(chromaticity of the surface of a test piece just after the test piece is prepared) Expression:

ΔE2=(chromaticity of the blocked surface of the irradiation after continuous irradiation with visible light for two hours)−(chromaticity of the surface of the test piece just after the test piece is prepared) Expression:

Thus, decomposing ability is evaluated based on a decoloring variation value ΔE=ΔE1−ΔE2. Evaluation criteria are as follows.

### Evaluation Criteria of Decomposing Ability

A: 25%≤ΔE

B: 10%≤ΔE<25%

C: ΔE<10%

### Dispersibility

The dispersibility is evaluated as follows. 0.05 g of particles obtained in each of the examples is put into a beaker, and 40 g of methyl ethyl ketone is added. Then, particle diameter distribution after dispersing is performed for 10 minutes in an ultrasonic dispersion machine is measured by NANOTRACK UPA-ST (a dynamic light scattering type particle diameter measuring device manufactured by Microtrac Bel). Thus, evaluation is performed by distribution form of volume particle diameter distribution. Evaluation criteria are as follows.

### Evaluation Criteria of Dispersibility

A: one peak value in the volume particle diameter distribution is provided, and dispersibility is good

B: two peak values in the volume particle diameter distribution are provided, but the main peak value is equal to or more than 10 times the other peak value. Thus, actually, there is no problem in dispersibility.

C: three peak values or more in the volume particle diameter distribution are provided, and dispersibility is poor.

Table 1 shows a list of the details and evaluation results of each of the examples.

TABLE 1

| | | Metal-containing compound | | | | UV-Vis characteristics | | |
|---|---|---|---|---|---|---|---|---|
| | | | | Added | | Absorbance of | Absorbance of | Absorbance of |
| | Material | Hydrocarbon | | amount | Heating | wavelength | wavelength | wavelength |
| | of particle | group | M | (weight %) | temperature | of 450 nm | of 600 nm | of 750 nm |
| Example 1 | metatitanic acid | isobutyl | Si | 40 | 400° C. | 0.46 | 0.38 | 0.26 |
| Example 2 | metatitanic acid | hexyl | Si | 40 | 400° C. | 0.60 | 0.42 | 0.27 |
| Example 3 | metatitanic acid | decyl | Si | 40 | 400° C. | 0.58 | 0.40 | 0.28 |
| Example 4 | metatitanic acid | hexyl | Si | 50 | 400° C. | 0.62 | 0.45 | 0.29 |
| Example 5 | metatitanic acid | hexyl | Si | 40 | 250° C. | 0.26 | 0.11 | 0.08 |
| Example 6 | metatitanic acid | isobutyl | Si | 40 | 500° C. | 0.38 | 0.26 | 0.14 |
| Example 7 | metatitanic acid | hexyl | Si | 25 | 400° C. | 0.38 | 0.27 | 0.15 |
| Example 8 | metatitanic acid | hexyl | Si | 75 | 400° C. | 0.61 | 0.45 | 0.28 |
| Example 9 | metatitanic acid | octyl | Si | 35 | 400° C. | 0.59 | 0.42 | 0.25 |
| Example 10 | metatitanic acid | methly | Si | 40 | 400° C. | 0.33 | 0.25 | 0.16 |
| Example 11 | metatitanic acid | HMDS | Si | 40 | 400° C. | 0.35 | 0.24 | 0.14 |
| Example 12 | metatitanic acid | dodecyl | Si | 30 | 400° C. | 0.60 | 0.44 | 0.27 |
| Example 13 | metatitanic acid | phenyl | Si | 40 | 400° C. | 0.26 | 0.19 | 0.12 |
| Example 14 | metatitanic acid | isobutyl | Si | 10 | 400° C. | 0.12 | 0.07 | 0.02 |
| Example 15 | metatitanic acid | hexyl | Si | 40 | 180° C. | 0.19 | 0.13 | 0.07 |
| Example 16 | metatitanic acid | hexyl | Si | 40 | 400° C. | 0.50 | 0.37 | 0.22 |
| Example 17 | metatitanic acid | hexyl | Si | 40 | 400° C. | 0.48 | 0.33 | 0.20 |
| Example 18 | metatitanic acid | hexyl | Si | 40 | 400° C. | 0.46 | 0.34 | 0.19 |
| Example 19 | metatitanic acid | hexyl | Si | 40 | 400° C. | 0.45 | 0.30 | 0.16 |
| Example 20 | metatitanic acid | C₁₈H₃₅ | Al | 40 | 400° C. | 0.30 | 0.20 | 0.19 |
| Comparative | anatase type | none | — | none | none | 0 | 0 | 0 |
| Example 1 | | | | | | | | |
| Comparative | rutile type | none | — | none | none | 0 | 0 | 0 |
| Example 2 | | | | | | | | |
| Comparative | anatase type | none | — | none | 400° C. | 0 | 0 | 0 |
| Example 3 | | | | | | | | |
| Comparative | rutile type | none | — | none | 400° C. | 0 | 0 | 0 |
| Example 4 | | | | | | | | |
| Comparative | metatitanic acid | isobutyl | Si | 5 | 400° C. | 0.02 | 0.01 | 0.01 |
| Example 5 | | | | | | | | |
| Comparative | metatitanic acid | isobutyl | Si | 120 | 400° C. | 0.63 | 0.45 | 0.29 |
| Example 6 | | | | | | | | |
| Comparative | metatitanic acid | isobutyl | Si | 40 | 600° C. | 0.07 | 0.04 | 0.02 |
| Example 7 | | | | | | | | |
| Comparative | metatitanic acid | isobutyl | Si | 40 | 160° C. | 0.02 | 0.01 | 0 |
| Example 8 | | | | | | | | |
| Comparative | metatitanic acid | isobutyl | Si | 40 | none | 0 | 0 | 0 |
| Example 9 | | | | | | | | |
| | | | XPS | | | | | |
| | | | M/Ti | C/Ti | O/(M + Ti) | | Evaluation | |
| | | | element | element | element | D50v | Decomposing | |
| | | | ratio | ratio | ratio | (μm) | ability | Dispersibility |
| | | Example 1 | 0.24 | 0.86 | 2.15 | 40 | A | A |
| | | Example 2 | 0.25 | 0.90 | 2.28 | 40 | A | A |
| | | Example 3 | 0.32 | 1.11 | 2.16 | 40 | A | A |
| | | Example 4 | 0.29 | 0.67 | 2.19 | 40 | A | A |
| | | Example 5 | 0.32 | 1.16 | 2.12 | 40 | A | A |
| | | Example 6 | 0.24 | 0.53 | 2.14 | 40 | B | A |
| | | Example 7 | 0.17 | 0.54 | 2.11 | 40 | A | A |
| | | Example 8 | 0.39 | 1.17 | 2.16 | 40 | A | A |
| | | Example 9 | 0.30 | 0.95 | 2.12 | 40 | A | A |
| | | Example 10 | 0.21 | 0.51 | 2.09 | 40 | B | A |
| | | Example 11 | 0.21 | 0.46 | 2.07 | 40 | B | A |
| | | Example 12 | 0.26 | 1.16 | 2.25 | 40 | B | A |
| | | Example 13 | 0.32 | 0.79 | 2.40 | 40 | B | B |
| | | Example 14 | 0.12 | 0.38 | 2.10 | 40 | B | A |
| | | Example 15 | 0.32 | 1.19 | 2.18 | 40 | B | A |
| | | Example 16 | 0.37 | 0.79 | 2.27 | 12 | A | A |
| | | Example 17 | 0.25 | 0.65 | 2.48 | 980 | A | A |
| | | Example 18 | 0.33 | 0.89 | 2.50 | 6 | B | B |
| | | Example 19 | 0.32 | 0.74 | 2.44 | 1,100 | B | A |
| | | Example 20 | 0.30 | 0.80 | 2.20 | 40 | B | B |
| | | Comparative | 0 | 0.19 | 2.03 | 12 | C | C |
| | | Example 1 | | | | | | |
| | | Comparative | 0 | 0.19 | 1.94 | 16 | C | C |
| | | Example 2 | | | | | | |
| | | Comparative | 0 | 0.16 | 1.97 | 12 | C | C |
| | | Example 3 | | | | | | |
| | | Comparative | 0 | 0.16 | 2.06 | 16 | C | C |
| | | Example 4 | | | | | | |
| | | Comparative | 0.03 | 0.22 | 1.82 | 40 | C | C |
| | | Example 5 | | | | | | |
| | | Comparative | 0.47 | 1.47 | 2.00 | 40 | C | B |
| | | Example 6 | | | | | | |
| | | Comparative | 0.13 | 0.26 | 2.62 | 40 | C | C |
| | | Example 7 | | | | | | |
| | | Comparative | 0.32 | 1.32 | 2.00 | 40 | C | A |
| | | Example 8 | | | | | | |
| | | Comparative | 0.32 | 1.37 | 1.96 | 40 | C | A |
| | | Example 9 | | | | | | |

It is understood from the above results that the examples have excellent decomposing ability as compared with the comparative examples. Thus, it is understood that the examples show a high photocatalyst function even in the visible light region as comparison with the comparative examples. It is understood that the examples also secure dispersibility.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A metatitanic acid particle comprising bonded thereon a metal-containing compound which has a hydrocarbon group,
wherein the metatitanic acid particle has an absorption at 450 nm and 750 nm in a visible absorption spectrum, and,
with respect to a surface of the particle, an element ratio M/Ti between metal M of the metal-containing compound and titanium is from 0 .1 to 0.4 and an element ratio C/Ti between carbon C and titanium is from 0.3 to 1.2.

2. The metatitanic acid particle according to claim 1,
which has an absorption in a range of wavelengths of 400 nm to 800 nm in the visible absorption spectrum.

3. The metatitanic acid particle according to claim 1,
wherein an element ratio O/(M+Ti) between oxygen 0 and a total of the metal M and titanium with respect to the surface of the particle is from 2.05 to 2.5.

4. The metatitanic acid particle according to claim 1,
wherein the metal of the metal-containing compound is silicon.

5. The metatitanic acid particle according to claim 1,
wherein the metal-containing compound which has a hydrocarbon group is a compound represented by R¹ₙMR²ₘ, wherein R¹ represents an aliphatic hydrocarbon group or an aromatic hydrocarbon group, which is saturated or unsaturated and has 1 to 20 carbon atoms, R² represents a halogen atom or an alkoxy group, n represents an integer of 1 to 3, and m represents an integer of 1 to 3, provided that n+m=4 is satisfied, in a case where n represents an integer of 2 or 3, plural R¹ may be the same or different, and in a case where m represents an integer of 2 or 3, plural R² may be the same or different.

6. The metatitanic acid particle according to claim 1,
wherein the hydrocarbon group is a saturated aliphatic hydrocarbon group.

7. The metatitanic acid particle according to claim 6,
wherein the number of carbon atoms of the saturated aliphatic hydrocarbon group is from 4 to 10.

8. The metatitanic acid particle according to claim 1,
which has a volume average particle diameter of from 10 nm to 1 μm.

9. A composition for forming a photocatalyst, comprising:
the metatitanic acid particle according to claim 1; and
at least one compound selected from the group consisting of a dispersion medium and a binder.

10. The composition for forming a photocatalyst according to claim 9,
wherein the dispersion medium contains water.

11. The composition for forming a photocatalyst according to claim 9,
wherein the binder is a thermoplastic resin.

12. The composition for forming a photocatalyst according to claim 9,
wherein the binder is a thermosetting resin having a siloxane bond.

13. The composition for forming a photocatalyst according to claim 9,
wherein the binder is an inorganic compound.

14. A photocatalyst comprising the metatitanic acid particle according to claim 1.

15. The photocatalyst according to claim 14, further comprising a promoter.

16. The photocatalyst according to claim 14, further comprising an adhesive.

17. The photocatalyst according to claim 14, further comprising a pressure-sensitive adhesive.
